(19) United States
(12) Patent Application Publication
(10) Pub. No.: US 2006/0277222 A1
(43) Pub. Date: Dec. 7, 2006

(54) Persistent data file translation settings

(75) Inventors: Richard L. Dickinson, Seattle, WA (US); Jianlan Song, Sammamish, WA (US); David E. Ashburn, Duvall, WA (US); Cyrus Balsara, Sammamish, WA (US); Clinton D. Covington, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/143,005

(22) Filed: Jun. 1, 2005

(51) Int. Cl. G06F 17/30

(52) U.S. Cl. 707/201

(57) ABSTRACT

A method, system, and computer-readable medium for creating and saving a translation specification are disclosed which enables settings information associated with data importation and exportation in a database to be saved for subsequent use. Saved settings information may be manipulated, selected for use, or exported to another application. Saved settings information exported to another application can take the form of a translation task, which will execute using the saved settings information. Recent translations may be temporarily saved, and later re-run, exported, or saved more permanently.

### TECHNICAL FIELD

The present invention relates generally to the field of software applications. More particularly, the present invention relates to software applications that import or export data, such as data from a database. More particularly still, aspects of the present invention relate to saving settings information associated with importing and exporting data in software applications.

### BACKGROUND OF THE INVENTION

In order to manage large quantities of data, computer software applications known as database applications have been developed to organize and store the data in a logical manner. Typical database applications comprise a large number of records of information, wherein each record comprises a predetermined number of fields. In the context of a database, a database management system is typically used to provide the software tools to manipulate the database more simply. Example database management systems include Microsoft® Access, and Microsoft® SQL Server, among others. A database management system typically provides the user the ability to add, modify or delete data, and the ability to translate data between formats. Translation may include importing data in various data formats, and exporting data to various data formats. More specifically, translation relates to the process of converting data from one format to another. This process typically occurs during an import or export operation.

Some database management systems have the capability to import data from a variety of different types of data sources. However, translations are typically required, and to do so, the database manager must understand aspects of the formatting of the imported data. A database management system might typically auto-detect some aspects relating to a file to be imported such as the type of file that has been selected for importation (e.g., an HTML file, XML file, text file, Excel spreadsheet, etc.) Other aspects of a file to be imported are more difficult to automatically detect. For example, in the case of a plain text file, data may be represented in an arbitrary number of ways; data values may be delimited by a space, comma, semicolon, carriage return, linefeed, or other ASCII symbol. Sets of data such as records, rows, or columns may be similarly arbitrarily delimited. When a characteristic of a file cannot be automatically detected, the user or database administrator must specify that characteristic since such information is required for a proper translation. Manually supplying such information is time consuming and burdensome. Moreover, undetected settings information must be manually supplied each time an importation takes place to achieve the desired translation.

Likewise, some database management systems have the capability to export data to a variety of different types of data sources. As with importation, it is necessary for the user or database administrator to specify characteristics relating to how the data will be exported. For example, in the case of data being exported to an HTML file, layout characteristics such as field formatting, column and row dimensions and spacing, and color may be required from a user. Undetected settings information must be manually supplied each time an exportation takes place to achieve the desired translation.

It is with respect to these considerations and others that the present invention has been made.

### SUMMARY OF THE INVENTION

In accordance with the present invention, a computer-implemented method is provided for creating a translation specification. First, a translation request is received, along with translation settings information. A translation is performed using the translation settings information, and the translation setting information is saved for future use.

In accordance with other aspects, the present invention relates to a system for saving and using translation settings information. An I/O module receives user input, and displays translation settings information and results. An importation module imports data, and saves importation settings information. An exportation module exports data, and saves exportation settings information. Finally, an execution module executes translations using saved translation settings information.

In accordance with yet other aspects, a computer readable medium accessible to a computing system and encoding a computer program is provided for creating a translation specification. First, a translation request is received, along with translation settings information. A translation is performed using the translation settings information, and the translation settings information is saved for future use.

The invention may be implemented as a computer process, a computing system, or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates a system that includes an exemplary screenshot showing a dialogue for saving translation settings information, and exporting it into another application.

FIG. 2 illustrates an example of a suitable computing system environment on which an embodiment of the present invention may be implemented.

FIG. 3 is a block diagram illustrating the modules that comprise one embodiment of the present invention.

FIG. 4 illustrates the operational flow of the operations performed in accordance with one embodiment of the present invention.

FIG. 5 illustrates the operational flow of the operations performed in accordance with one embodiment of the present invention.

FIG. 6 illustrates the operational flow of the operations performed in accordance with one embodiment of the present invention.

FIG. 7 illustrates an example screenshot showing a dialogue for managing and using saved translation settings information, and exporting it into another application.

### DETAILED DESCRIPTION OF THE INVENTION

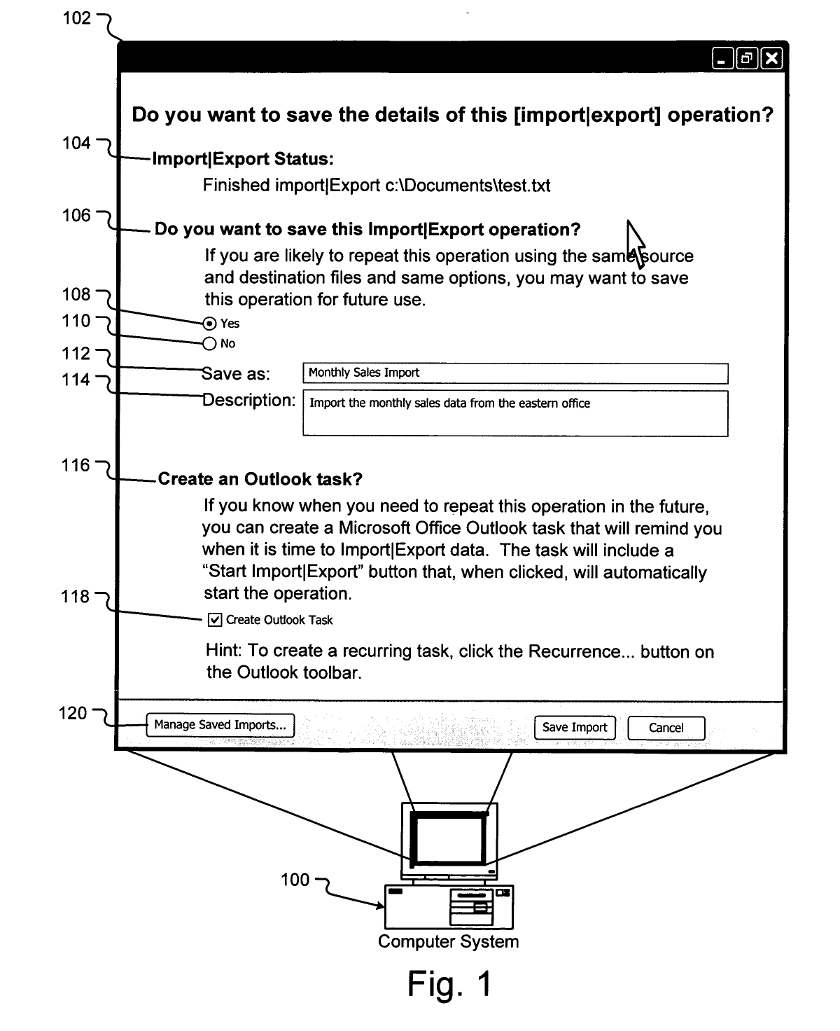

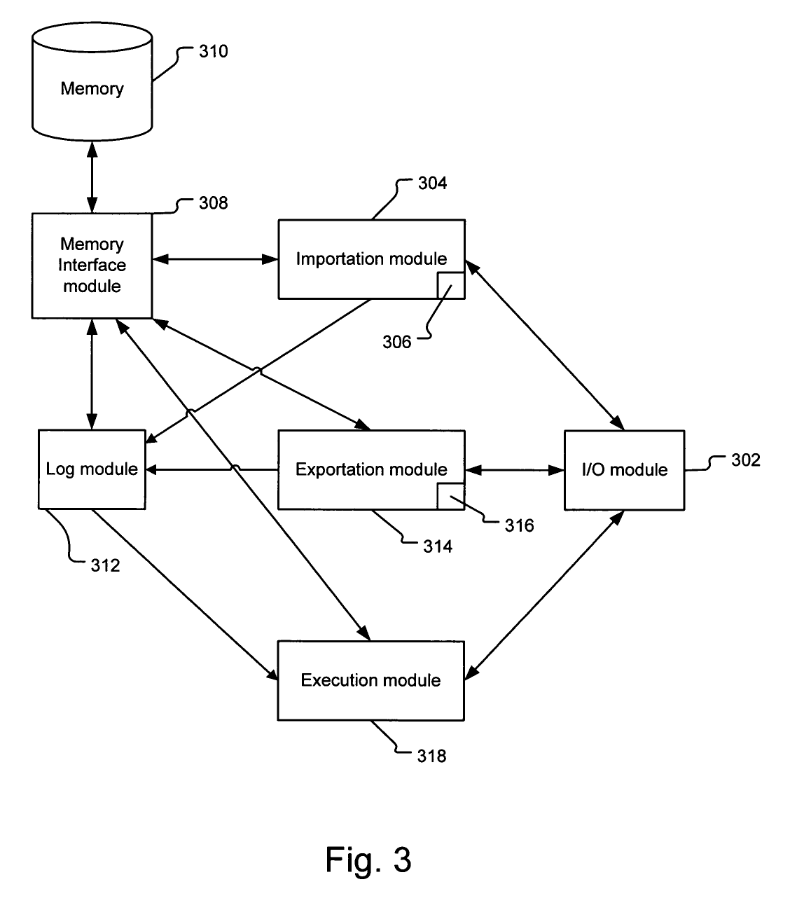

Embodiments of the claimed invention allow translation settings information associated with an import and/or export to be saved for future use. Other embodiments of the claimed invention allow exporting the saved settings information as an operation in a third party application. FIG. 1 illustrates a computer system 100 including an exemplary screenshot showing a dialogue box 102 for saving translation settings information, and exporting the settings as a Task in Microsoft® Outlook. The dialogue box 102 is displayed on a computer display, such as a monitor, as part of computer system 100. Typically, the computer system 100 provides communication capabilities to a database or other backend data storage system. As discussed in the Background section, translation attributes are often required to import or export the data from or to a backend database. Embodiments of the present invention involve storing such translation settings for future use, e.g., through the use of translation save modules 306 and 316 (shown and described below, in conjunction with FIG. 3). Dialogue box 100 provides an exemplary overview of some of the functional features provided by embodiments of the present invention.

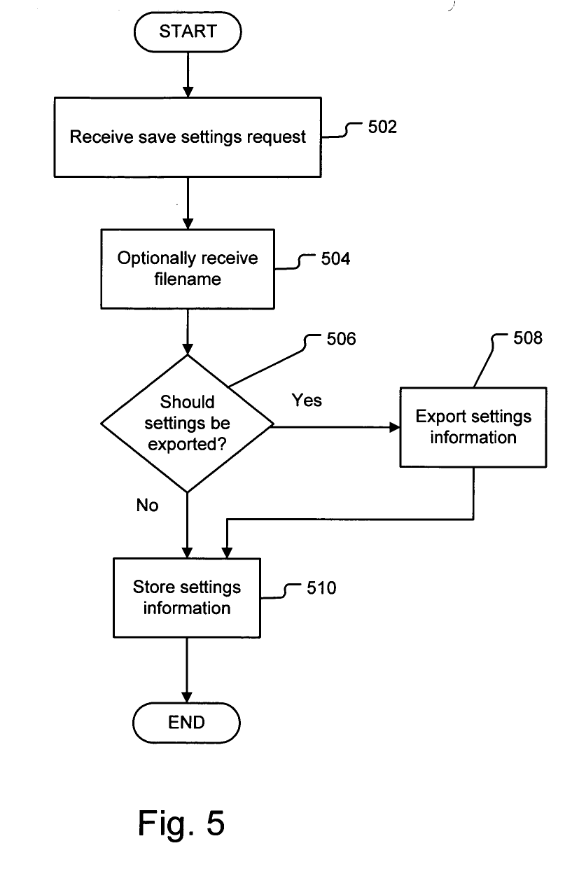

Status report 104 reports the status of the current translation. In the illustrated embodiment, the translation has been completed. Prompt 106 indicates that the translation settings information may be saved for later use, and prompts the user to save the translation settings information. If the “No” radio button 110 is checked, dialog box 102 will close without saving settings information. In an alternate embodiment, if the “No” radio button 110 is checked, the settings information will be saved temporarily in a log of translation settings information. Such a log may hold settings information from a number of recent translations, allowing a user who chose not to save settings information to change his or her mind later, and retrieve the settings information without needing to re-specify translation characteristics or perform a new translation. The number of recent translations that are saved may be derived from a variety of sources. For example, the number may be set by a user, set using a default value, or set based on the amount of free memory in which to store translations. Logs are discussed in more detail below, in conjunction with FIG. 5.

If the “Yes” radio button 108 is checked, the user is prompted to enter information relating to saving the translation settings information. More specifically, prompt 112 prompts the user for a name for the translation settings information, while prompt 114 prompts the user for an optional description of the translation. This information can be used to create a catalog of saved translation settings information that a user may subsequently access. In one exemplary embodiment, manage translations button 120 allows access to the catalog.

Another capability presented to the user by dialog box 102 is that of exporting translation settings information to another application. That is, the settings may be stored for reuse, and then packaged into yet another format, such as a format appropriate for use by a third party. In the illustrated embodiment, prompt 116 informs the user of this capability, and checkbox 118, if selected, will save translation settings information as a task in Microsoft® Outlook. An Outlook user may subsequently execute the task simply by selecting it from a list of tasks, and thus repeat the translation using the previously determined translation settings information.

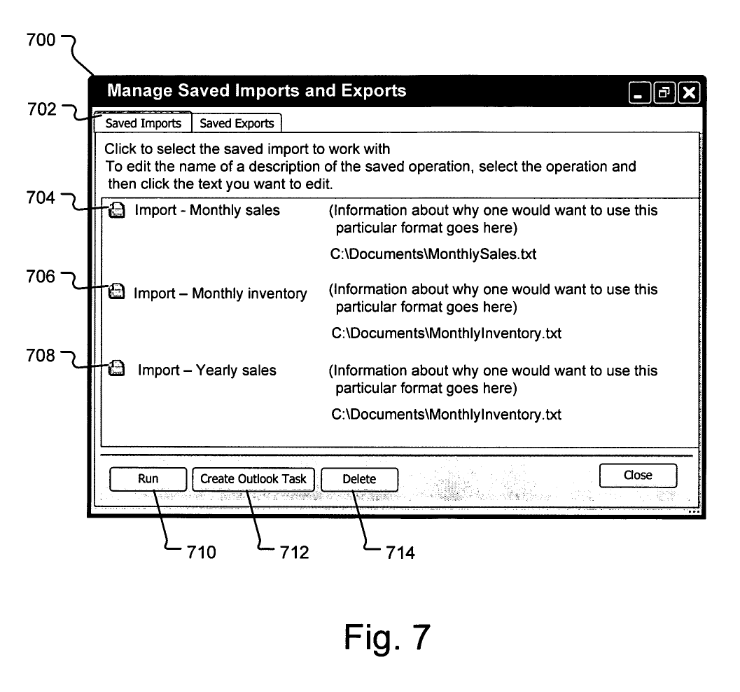

Manage translations button 120 causes a list of all saved translation settings information (FIG. 7) including names and descriptions to be displayed. In an embodiment, translation settings information may be selected to trigger execution of a translation using the selected translation settings information. In another embodiment, translation settings information in the list can be edited or deleted.

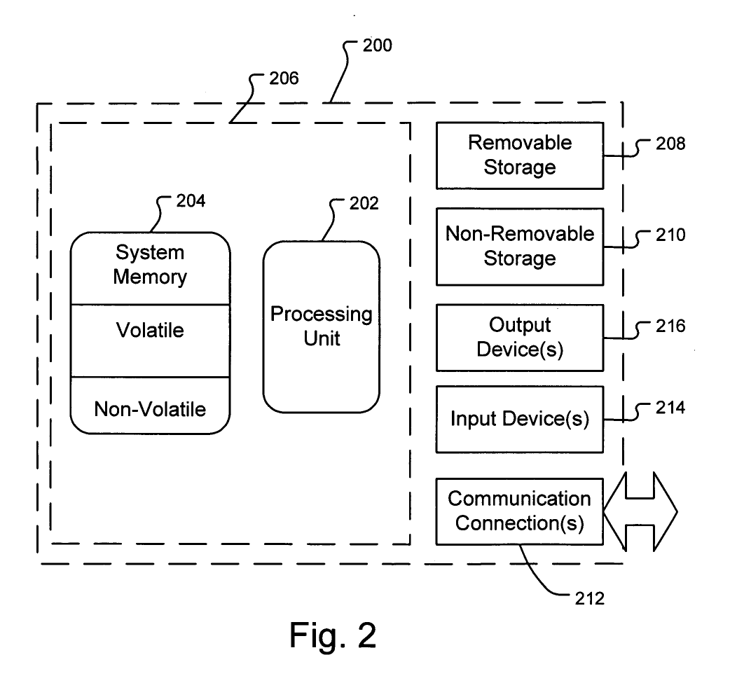

As may be appreciated, the present invention may be implemented on a computer system, FIG. 2 is provided to illustrate an example of a suitable computing system environment on which embodiments of the invention may be implemented. In its most basic configuration, system 200 includes at least one processing unit 202 and memory 204. Depending on the particular configuration and type of computing device, memory 204 may be volatile (such as RAM), non-volatile (such as ROM, flash memory, etc.) or some combination of the two. This type of basic configuration is illustrated in FIG. 2 by dashed line 206.

In addition to the memory 204, the system may include at one or more other forms of computer-readable media. Computer-readable media can be any available media that can be accessed by the system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Memory 204, removable storage 208, and non-removable storage 210 are all examples of computer storage media. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 200. Any such computer storage media may be part of system 200.

System 200 may also contain a communications connection(s) 212 that allow the system to communicate with other devices. The communications connection(s) 212 exemplifies use of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In accordance with an embodiment, the system 200 includes peripheral devices, such as input device(s) 214 and/or output device(s) 216. Exemplary input devices 214 include, without limitation, keyboards, computer mice, pens, or styluses, voice input devices, tactile input devices and the like. Exemplary output device(s) 216 include, without limitation, devices such as displays, speakers, and printers. Each of these devices is well know in the art and, therefore, not described in detail herein.

Embodiments of the present invention allow saving importation settings information and/or exportation settings information, subsequent execution of a translation according to the saved settings information, management of saved settings information, and the logging of settings information not specified to be saved, among other features. FIG. 3 is a block diagram illustrating some of the modules used to perform some of these tasks in accordance with one embodiment of the present invention.

Input and output (I/O) module 302 provides a user interface with which users can indicate their request to save translation settings information, and request to use and/or manage saved translation settings information. I/O module 302 passes information regarding a translation to importation module 304 and exportation module 314 as needed. Likewise, I/O module 302 enables users to interact with execution module 318 when using or managing saved translation settings information.

Importation module 304 gathers information regarding data importation such as the name and type of an imported data file, which subsets of data in the file to import, and other importation settings information. Importation module 304 includes a save module 306, which may optionally save settings information after the importation is complete. Importation module 304 may also gather file-type specific importation data such as how fields in a text file are delimited, and save the data using save module 306. In an embodiment, importation module 304 also gathers settings information relating to saving the imported data, such as a name and/or a description of the importation. Data may be gathered by saving user inputs, saving the results of automated detection, or other method. In yet another embodiment, importation module 304 gathers settings information relating to exporting the saved importation information to another application such as Microsoft® Outlook. Save module 306 sends saved importation settings information to memory interface module 308. Memory interface module 308 interfaces with memory 310 for reads and writes, where memory 310 may be volatile memory, non-volatile memory, or any computer-writeable medium. Save module 306 may optionally send unsaved importation settings information to log module 310 for saving. In an embodiment, save module 306 saves both user-entered settings information (such as file name) and automatically detected settings information (such as file type) to save the time and resources associated with processing a data file in performing future automatic detection.

Log module 312 saves translation settings information that users do not explicitly request to be saved. The settings information may later be recalled by a user who inadvertently failed to request that the settings information be saved, whether to expressly save such settings information or to simply redo a recent translation. Log module 312 may store settings information for a predetermined period of time, or maintain and delete settings information based on usage. In one embodiment, log module 312 stores settings information from the most recent n translations, where n is an integer set by a user, set using a default value, set based on how much free memory exists, etc. Log module 312 receives translation settings information from importation module 304 for storage in memory 310 by way of memory interface module 308, and receives translation settings information from exportation module 314 for storage in memory 310 by way of memory interface module 308. Memory 310 may be volatile memory, non-volatile memory, or any computer-writeable medium. Log module 312 sends translation settings information to execution module 318 for translation settings information management, and for execution of a translation using the translation settings information. As may be appreciated, log module 308 is not necessary in many embodiments of the present invention, wherein users expressly save settings information.

Exportation module 314 gathers information regarding data exportation such as the name and type of the data file to which the data is exported, which columns or rows to export, etc. Exportation module 314 includes a save module 316 which optionally saves translation settings information after the exportation is complete. Save module 316 sends saved exportation settings information to memory interface module 308, which writes it to memory 310, where memory 310 may be volatile memory, non-volatile memory, or any computer-writeable medium. Exportation module 314 may also gather file-type specific exportation settings information such as how fields in a text file are delimited, data layout and formatting in XML or HTML files, etc. Exportation module 314 may gather data by saving user inputs, saving the results of automatically detected settings, or other method. The settings information may then be saved by save module 316. In an embodiment, exportation module 314 also gathers settings information relating to saving the exportation settings information, such as a name and/or a description of the exportation. In yet another embodiment, exportation module 304 gathers settings information relating to exporting the saved exportation settings information to another application such as Microsoft® Outlook. Save module 316 sends saved exportation settings information to memory interface 308 for storage in memory 310, and save module 316 may optionally send unsaved exportation settings information to log module 312 for saving, as described above in relation to importation settings.

Execution module 318 allows management and use of saved translation settings information. Execution module 318 retrieves saved translation settings information from memory 310 by way of memory interface module 308, and executes translations using the saved translation settings information. Execution module 318 may also receive saved translation settings information from log module 312 for use with an executed translation, or for conversion into more permanently saved settings information to be stored in memory 310 by way of memory interface module 308. In conjunction with I/O module 302, execution module 318 may be used to browse, select for use, and manage saved translation settings information. In an embodiment, execution module 318 also allows exporting already-saved settings information to another application such as Microsoft® Outlook. Translation settings associated with a translation may be presented as an item in a menu of saved settings information, as an icon, or other graphical representation. In an embodiment, execution module 318 allows a user to modify settings information from a previous translation. For example, a user may select a previous translation from which to take settings information, but alter one or more settings such as the name of the translation or format of the input or output. In this way, existing saved translation information from a previous translation can be leveraged to quickly create translation information for one or more new translations.

In an embodiment, translation settings information is stored in one or more XML files. These files are then associated with a data file being imported, or with a data file being exported. However, translation settings information may just as readily be stored in any other format by which data may be encoded that is known in the art. In another embodiment, translation settings information may be stored as metadata in the file that contains the translated data. In yet another embodiment, translation settings information may be saved as one or more records in a master file associated with the database to which the settings relate.

In an embodiment, the translation settings information saved by save module 306, save module 316, and log module 312, and used by execution module 318 may include transformation specifications. Transformation is a method by which data is encoded according to arbitrarily complex predefined rules. Transformation rules may themselves be stored in translation settings information by modules 306, 312, and 316, and/or references to one or more rules or sets of rules may be stored in translation settings information by modules 306, 312, and 316.

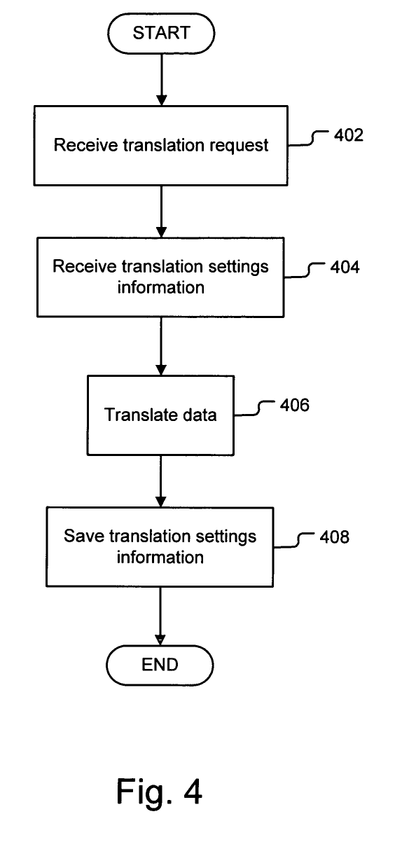

When a translation is processed, the associated translation settings information is captured for future use. FIG. 4 illustrates the operational flow of this process in accordance with one embodiment of the present invention. First, receive operation 402 receives a request for a translation. The translation may be in response to an importation action or an exportation action. The request identifies a file or database entity that is to be translated. The request may come from a user, such as through I/O module 302. Alternatively, the request may be automatically generated in response to an import request or export request.

Next, receive operation 404 receives settings information associated with a translation. Typical settings information includes, but is not limited to, the type of file that is to be translated (in the case of an importation) or where the translated data will be stored (in the case of an exportation), which data within a data source is to be translated, which data transformations (if any) should be applied to the data during the translation, and data format information such as delimiters, spacing, and textual formatting. In the case of importation, receive operation 404 may receive a specification as to whether the imported data will be placed in a new table, or appended to an existing table, for example. Additionally, receive operation 404 may receive a specification of whether an importation should be physically copied into a table, or just linked into the table such that the actual data continues to be stored in the original data file. Receive operation 404 may receive settings information from a user, or from an automated computer agent. In an embodiment, some settings information is automatically detected and need not be specified manually by a user.

Translate operation 406 then performs the translation on the data in the request received during operation 402. The translation uses the settings information received by receive operation 404. Translation may relate to importing a file into a database, or exporting data from a database to a file, both of which may be accomplished through a variety of methods known in the art. Translate operation 406 may also perform data transformation using methods known in the art.

Save operation 408 then saves some or all of the settings information received by receive operations 402 and 404. In an embodiment, settings information is stored in one or more XML files which are associated with the imported data, or the data file to which data is exported. In another embodiment, settings information is associated with the actual database data itself. In yet other embodiments, settings information may be stored in other formats such as HTML, hexadecimal, or as metadata within a database. In one embodiment, save operation 408 may occur prior to translation operation 406.

In an embodiment, a variety of specifications are received from a user as to how a given set of translation settings information should be stored. FIG. 5 illustrates the operational flow of this process in accordance with one embodiment of the present invention. First, receive operation 502 receives a request to save a translation specification (a set of translation settings information). The translation specification may relate to an importation, an exportation, or a combination of both importations and exportations. In an embodiment, a translation specification save request is made by a user selecting a control such as “Yes” radio button 108 (FIG. 1) in response to a prompt such as prompt 106 (FIG. 1). Of course, other user interface controls may be used to allow a user to request saving a translation specification.

Receive operation 504 optionally may receive a name for the translation specification. This name may be used later to reference the translation settings information. The name may also be used as a filename for the file in which the settings information will be stored. Alternatively, the name may be used as a record name within a database entity which contains translation settings information. In an embodiment, the name may be used to identify the settings information from a list using the settings information management capabilities of execution module 318 (FIG. 3). In an embodiment, a translation name is specified by a user by way of a text field such as the text box associated with prompt 112 (FIG. 1). In an alternative embodiment, a default name or automatically generated name for the translation is used.

Determine operation 506 determines whether the settings information in the translation specification to be saved should also be exported to another application. In an embodiment, receive operation 502 receives information indicating whether such an action should occur. In another embodiment, the determination is made based on the value of export checkbox 118 (FIG. 1). If the settings information should be exported, flow branches YES to export operation 508. If the settings information need not be exported, flow branches NO to store operation 510.

Export operation 508 exports translation settings information to another application. For example, in one embodiment, export operation 508 may export translation settings information in the form of a task in Microsoft® Outlook. In an embodiment, a task includes a list of commands to run via batch file, script, or other method, and a task name. A task, when selected by an Outlook user, may automatically trigger a translation using the exported translation settings information. Such a translation could therefore be scheduled to execute periodically with the help of a scheduling program such as Microsoft® Outlook. Alternatively, a reminder to execute the task could be periodically scheduled. Export operation 508 specifies to the external application a task name (based on the name received by receive operation 504) and a series of operations that will comprise the task. In an embodiment, the operations embodied by translation operation 406 (FIG. 4) are specified to the external application along with any required translation settings information. While the described exemplary embodiment exports a translation specification to Microsoft® Outlook, exporting to other applications is also envisioned. More specifically, exporting settings information and/or tasks to applications which support data importation or exportation, or which are capable of performing automated tasks, is envisioned.

Store operation 510 stores the settings information associated with the translation for future use. In an embodiment, settings information is stored in one or more XML files which are associated with the imported data, or the data file to which data is exported. In another embodiment, settings information is associated with the actual database data itself. In yet other embodiments, settings information may be stored in other formats such as HTML, hexadecimal, or as metadata within a database. Settings information may additionally be stored in association with a log of recent or frequently used translations.

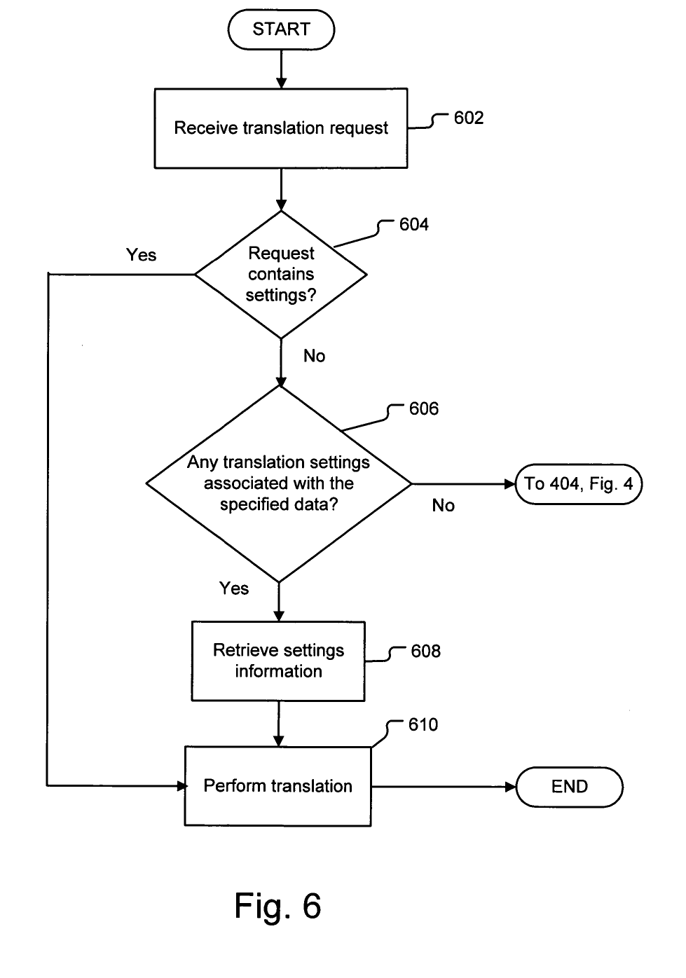

The performance of a translation may be initiated in a variety of ways. For example, a user may request translation of data, and an embodiment may detect that saved settings information is associated with that data and allow the user to use the saved settings information. Alternatively, a user may select a saved translation from a list translations with associated saved settings information, which will initiate a translation using the settings information. FIG. 6 illustrates the operational flow in accordance with one embodiment of the present invention in which a translation may be initiated in either of the described ways.

Receive operation 602 receives a translation request from a user. As indicated previously, the translation request may be made in a variety of contexts. For example, a translation request made by selecting a saved translation from a list will implicitly contain or be associated with translation settings information to be used in conjunction with the translation. However, if a translation was initiated by merely selecting a data entity, translation settings information may or may not be stored in association with that entity. Determine operation 604 determines whether translation settings information is implicit in a translation request. If translation settings information is implicit in the request, flow branches YES to perform operation 612. However, if translation settings information is not implicit in the request, flow branches NO to check operation 606.

If a translation request does not implicitly contain translation settings information, determine operation 606 determines if any saved translation settings information is associated with the data to be translated. In one embodiment, determine operation 606 checks for one or more records in a translation settings information database that corresponds to the data. In another embodiment, determine operation 606 checks for metadata in a database file that would indicate saved translation settings information exists. If no translation settings information is found in association with a translation request, flow branches NO to receive operation 404 (FIG. 4), and translation settings information is subsequently received from a user. If translation settings information is found in association with a translation request, flow branches YES to retrieve operation 608.

Retrieve operation 608 retrieves and processes the translation settings information found by determine operation 606. In an embodiment, retrieve operation retrieves one or more records in a translation settings information database that corresponds to the data to be translated.

If determine operation 604 found translation settings information within the translation request received by receive operation 602, perform operation 610 performs the requested translation using that translation settings information. Conversely, if determine operation 604 did not find translation settings information within the translation request received by receive operation 602, perform operation 610 performs the requested translation using the translation settings information retrieved by retrieve operation 608.

In an embodiment, a wizard queries the user for translation settings information such as format, delimiters, and other data that is specific to the type of file. In an embodiment, some translation settings information may be implicit in a request, while others are not, and thus only a subset of operations 606 and 608 are performed prior to perform operation 610.

FIG. 7 shows a dialogue box 700 presented to a user, such as through 1/O module 302, for managing and using saved translation settings information, and potentially exporting it into another application in accordance with one embodiment of the present invention. Folder bar 702 allows users to select between saved import specifications and saved export specifications. In the screenshot, saved import translation specifications 704, 706, and 708 are shown. Each of saved import translation specifications 704, 706, and 708 is shown with a name (in the left column), along with an indication of which data will be imported and a written description of the import (right column).

Buttons 710, 712, and 714 allow management, exportation, and execution of translations. Run button 710 will execute one or more selected translations. Export button 712 will export one or more selected translation specifications to Microsoft® Outlook in the form of an executable task. Finally, delete button 714 will delete one or more selected translation specifications.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A computer-implemented method for managing translation settings information comprising:
receiving a translation request;
receiving translation settings information;
performing a translation; and
saving the translation settings information.

2. A computer-implemented method as defined in claim 1, wherein the translation is a data import.

3. A computer-implemented method as defined in claim 1, wherein the translation is a data export.

4. A computer-implemented method as defined in claim 1, further comprising presenting a menu of translation settings information.

5. A computer-implemented method as defined in claim 1, wherein said translation settings information is comprised of a selection a subset of data to translate.

6. A computer-implemented method as defined in claim 1, wherein said translation settings information is comprised of one or more data formatting settings.

7. A computer-implemented method as defined in claim 1, wherein said translation settings information is comprised of one or more data transformation settings.

8. A computer-implemented method as defined in claim 1, wherein said translation settings information is comprised of one or more data field delimiter settings.

9. A computer-implemented method as defined in claim 1, further comprising using the translation specification in conjunction with performing one or more subsequent translations.

10. A system for saving and using translation settings information comprising:
an I/O module for receiving user input, and displaying translation settings information and translation results;
an importation module for importing data and saving importation settings information;
an exportation module for exporting data and saving exportation settings information; and
an execution module for executing translations using saved translation settings information.

11. A system as defined in claim 10, further comprising a log module for s a v i n g settings information from recent translations.

12. A system as defined in claim 10, wherein said execution module allows management of saved translation settings information.

13. A system as defined in claim 10, wherein said execution module allows exportation of saved translation settings information to another application.

14. A system as defined in claim 13, wherein said another application allows scheduling one or more translations using said saved translation settings information.

15. A computer readable medium accessible to a computing system and encoding a computer program for creating a translation specification comprising:
receiving a translation request;
receiving translation settings information;
performing a translation; and
saving said translation settings information.

16. A computer readable medium as defined in claim 15, further comprising presenting a menu of translation specifications for selection and manipulation.

17. A computer readable medium as defined in claim 15, further comprising using the translation specification in conjunction with performing one or more subsequent translations.

18. A computer readable medium as defined in claim 15, wherein said saving translation settings information is performed in response to a request from a user.

19. A computer readable medium as defined in claim 15, wherein said saving translation settings information is performed automatically.

20. A computer readable medium as defined in claim 19, wherein said saved translation settings information is maintained or deleted based on frequency of usage.
